(19) United States
(12) Patent Application Publication
(10) Pub. No.: US 2017/0190291 A1
(43) Pub. Date: Jul. 6, 2017

(54) Vehicle Exterior Mirror

(71) Applicant: Wen-Pin TSENG, Changhua County (TW)

(72) Inventor: Wen-Pin TSENG, Changhua County (TW)

(21) Appl. No.: 15/171,472

(22) Filed: Jun. 2, 2016

(30) Foreign Application Priority Data
Dec. 31, 2015 (TW) 104221382

(51) Int. Cl. B60R 1/12; G03B 17/56; H04N 5/225; G02B 7/02

(52) U.S. Cl. CPC B60R 1/12; G02B 7/021; G03B 17/561; H04N 5/2254; B60R 2001/1253; B60R 2300/101; B60R 2300/8026

(57) ABSTRACT

A vehicle exterior mirror contains: a body and a camera. The body includes a casing on which at least one lens assembly are mounted, and the casing accommodates at least one rotating apparatus, the at least one lens assembly is in connection with the at least one rotating apparatus respectively and has at least one through orifice defined thereon, individually. The camera passes through the at least one through orifice of the at least one lens assembly and fits with the at least one lens assembly.

### FIELD OF THE INVENTION

The present invention relates to a vehicle, and more particularly to a vehicle exterior mirror for the vehicle.

### BACKGROUND OF THE INVENTION

A conventional vehicle exterior mirror is fixed on a vehicle so as to eliminate blind spot of a reflection lens of the conventional vehicle exterior mirror, thus avoiding traffic accident.

To overcome above-mentioned problem, a camera assembly is secured on the vehicle exterior mirror, such as a casing of the vehicle exterior mirror, such that when the reflection lens of the vehicle exterior mirror is adjusted to a desired angle according to using requirements, the camera assembly cannot be adjusted to the desired angle in response to a rotation of the camera assembly, because the camera assembly is secured on the casing, thus reducing using satisfaction and safety.

A photograph lens, disclosed in U.S. Pat. No. 9,022,586, is mounted on a back surface of an opening of a reflection lens so that the photograph lens shoots images clearly from the opening of the reflection lens, wherein the opening reflects the images of the camera and does not obstruct the reflection lens. However, the photograph lens is mounted on the back surface of the reflection lens, so it refracts lights, decreases clarity of the images, and gets dirty.

The present invention has arisen to mitigate and/or obviate the afore-described disadvantages.

### SUMMARY OF THE INVENTION

The primary objective of the present invention is to provide a vehicle exterior mirror which is capable of overcoming the shortcomings of the conventional vehicle exterior mirror.

Another objective of the present invention is to provide a vehicle exterior mirror which is capable of adjusting at least one lens assembly and a camera to a desired angle simultaneously based on using requirements.

To obtain the above objectives, a vehicle exterior mirror provided by the present invention contains: a body and a camera.

The body includes a casing on which at least one lens assembly is mounted, and the casing accommodates at least one rotating apparatus, the at least one lens assembly is in connection with the at least one rotating apparatus respectively and has at least one through orifice defined thereon, individually.

The camera passes through the at least one through orifice of the at least one lens assembly and fits with the at least one lens assembly.

Preferably, the at least one lens assembly of the body includes a first lens assembly and a second lens assembly which are both mounted on one surface of the casing, and the first lens assembly is mounted on an upper side of the one surface of the casing, the second lens assembly is mounted on a lower side of the one surface of the casing.

Preferably, the at least one lens assembly of the body includes a first lens assembly and a second lens assembly which are both mounted on one surface of the casing, and the first lens assembly is mounted on a left side of the one surface of the casing, the second lens assembly is mounted on a right side of the one surface of the casing.

Preferably, the at least one rotating apparatus is an electric rotating apparatus or a manual rotating apparatus.

Preferably, the second lens assembly has a fixing mount and a lens connected with the fixing mount, and the fixing mount is coupled with the at least one rotating apparatus, the at least one through orifice has a first through orifice and a second through orifice, and the first through orifice defines on the fixing mount of the second lens assembly, the second through orifice defines on the lens of the second lens assembly and corresponds to the first through orifice, wherein a diameter of the first through orifice of the fixing mount is more than or equal to the second through orifice of the lens. The camera includes a photograph lens module and a locking element, the photograph lens module has a camera lens arranged on a first end thereof, a peripheral tab adjacent to the camera lens, and a connection portion formed on a second end thereof proximate to the peripheral tab, wherein a diameter of the peripheral tab is more than the second through orifice of the second lens assembly, a diameter of the connection portion is less than the second through orifice of the second lens assembly, the connection portion of the photograph lens module is fitted with the second through orifice of the second lens assembly and the first through orifice of the fixing mount, and the locking element is screwed with the connection portion so that the camera fits with the fixing mount.

Preferably, the connection portion has a threaded section defined thereon, and the locking element is a nut configured to screw with the threaded section.

Preferably, the camera is fitted with a first sealing element between the peripheral tab and the second lens assembly.

Preferably, the camera is fitted with a second sealing element between the second lens assembly and the locking element.

Preferably, the diameter of the first through orifice of the fixing mount is more than the locking element.

Preferably, the diameter of the first through orifice of the fixing mount is less than the locking element.

### BRIEF DESCRIPTION OF THE DRAWINGS

FIG. 1 is a perspective view showing the exploded components of a vehicle exterior mirror according to a first embodiment of the present invention.

FIG. 2 is an amplified perspective view showing the assembly of a part of the vehicle exterior mirror according to the first embodiment of the present invention.

FIG. 3 is a perspective view showing the exploded components of FIG. 2.

FIG. 4 is a cross sectional view taken along the line 4-4 of FIG. 2.

FIG. 5 is a perspective view showing the application of the vehicle exterior mirror according to the first embodiment of the present invention.

FIG. 6 is a perspective view showing the assembly of a vehicle exterior mirror according to a second embodiment of the present invention.

FIG. 7 is a perspective view showing the exploded components of the vehicle exterior mirror according to the second embodiment of the present invention.

### DETAILED DESCRIPTION OF THE PREFERRED EMBODIMENTS

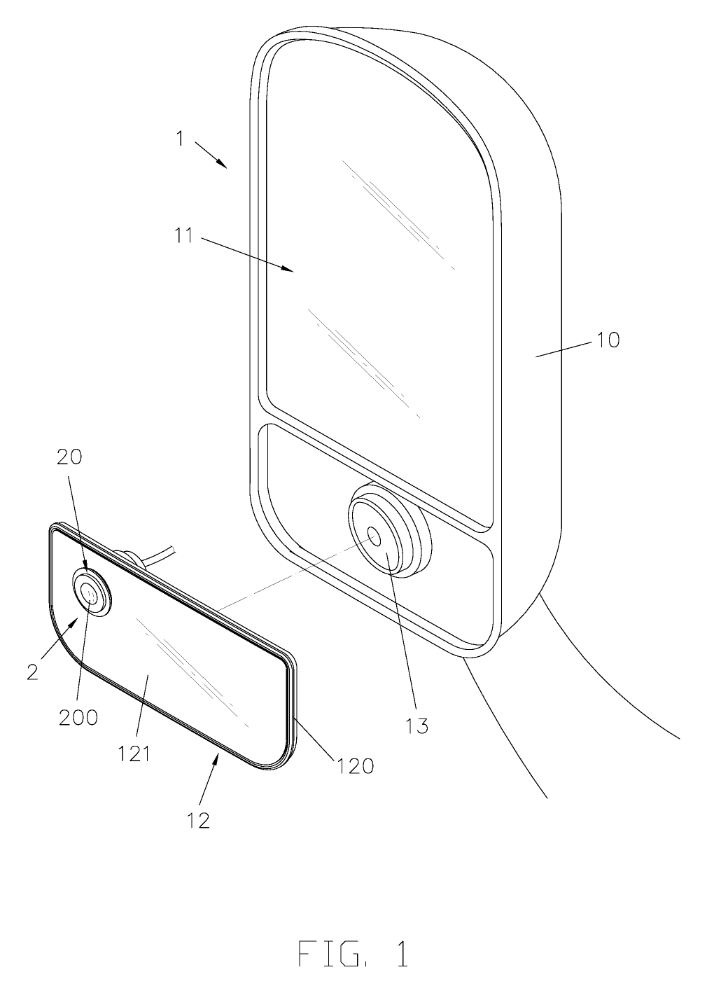

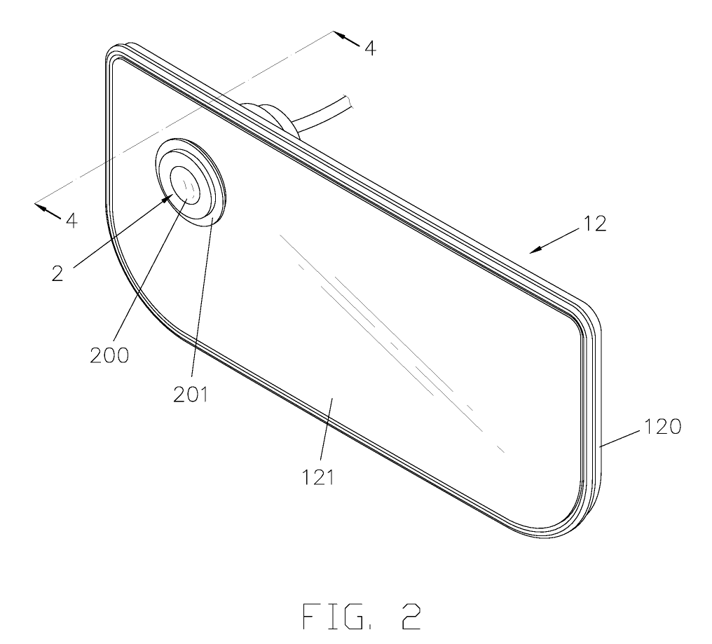

With reference to FIGS. 1 to 3, a vehicle exterior mirror according to a first embodiment of the present invention comprises: a body 1 and a camera 2.

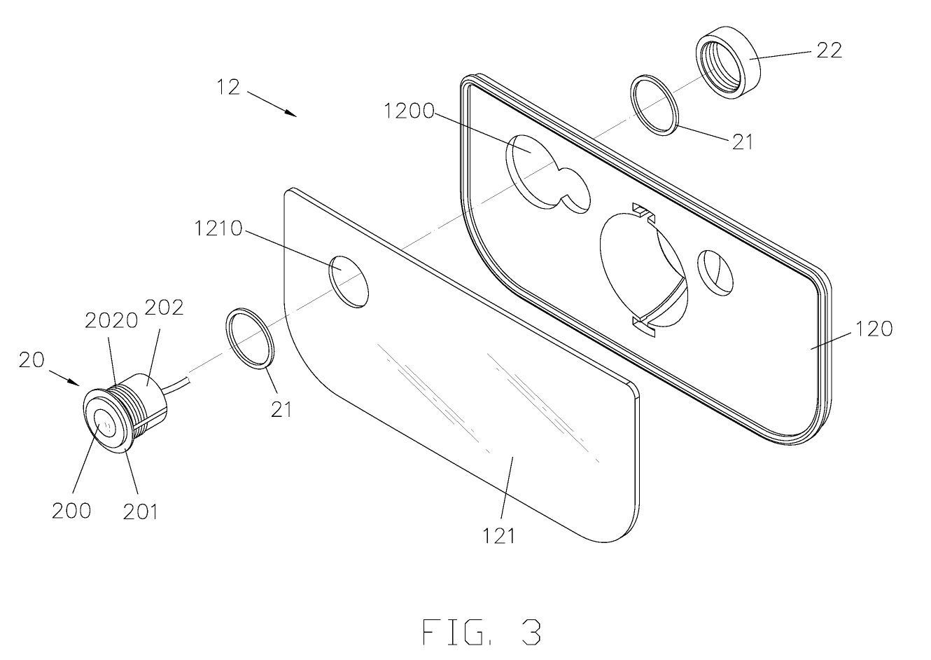

The body 1 includes a casing 10, a first lens assembly 11, a second lens assembly 12, and at least one rotating apparatus 13. The first lens assembly 11 and the second lens assembly 12 are longitudinally mounted on one surface of the casing 10 (for example, the first lens assembly 11 is mounted on an upper side of the one surface of the casing 10, and the second lens assembly 12 is mounted on a lower side of the one surface of the casing 10, as shown in FIG. 1), and the casing 10 accommodates a rotating apparatus 13 which is in connection with the second lens assembly 12, such that the rotating apparatus 13 drives the second lens assembly 12 to rotate to a desired angle. Preferably, the rotating apparatus 13 is an electric rotating apparatus or a manual rotating apparatus. The second lens assembly 12 has a fixing mount 120 and a lens 121 connected with the fixing mount 120, and the fixing mount 120 is coupled with the rotating apparatus 13. The second lens assembly 12 has at least one through orifice defined thereon and passing through the fixing mount 120 and the lens 121, for example, a first through orifice 1200 defines on the fixing mount 120 of the second lens assembly 12, and a second through orifice 1210 defines on the lens 121 of the second lens assembly 12 and corresponds to the first through orifice 1200, wherein a diameter of the first through orifice 1200 of the fixing mount 120 is more than or equal to the second through orifice 1210 of the lens 121. As shown in FIG. 3, the diameter of the first through orifice 1200 of the fixing mount 120 is more than the second through orifice 1210 of the lens 121.

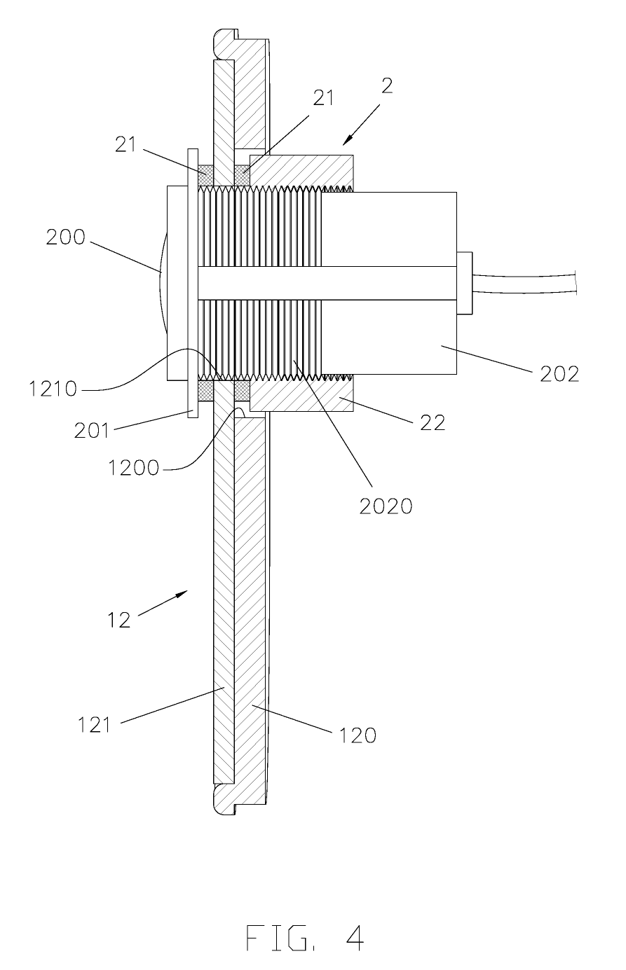

Referring further to FIGS. 3 and 4, the camera 2 includes a photograph lens module 20, two sealing elements 21, and a locking element 22. The photograph lens module 20 has a camera lens 200 arranged on a first end thereof, a peripheral tab 201 adjacent to the camera lens 200, and a connection portion 202 formed on a second end thereof proximate to the peripheral tab 201, wherein a diameter of the peripheral tab 201 is more than the second through orifice 1210 of the second lens assembly 12, the connection portion 202 has a threaded section 2020 defined thereon and its diameter of the connection portion 202 is less than the second through orifice 1210 of the second lens assembly 12. The connection portion 202 of the camera 2 is fitted with a first sealing element 21 between the peripheral tab 201 and the second lens assembly 12, the second through orifice 1210 of the second lens assembly 12, and a second sealing element 21 so as to screw with the locking element 22 (such as a nut) by way of the threaded section 2020. The diameter of the first through orifice 1200 of the fixing mount 120 is more than the first and second sealing elements 21 and the locking elements 22 so that the second sealing element 21 abuts against the second lens assembly 12 and the locking element 22, and the first sealing element 21 contacts with the second lens assembly 12. In another embodiment, the diameter of the first through orifice 1200 of the fixing mount 120 is less than the locking element 22 so that the second sealing element 21 abuts against the fixing mount 120 and the locking element 22, and the photograph lens module 20 is fixed on the second lens assembly 12.

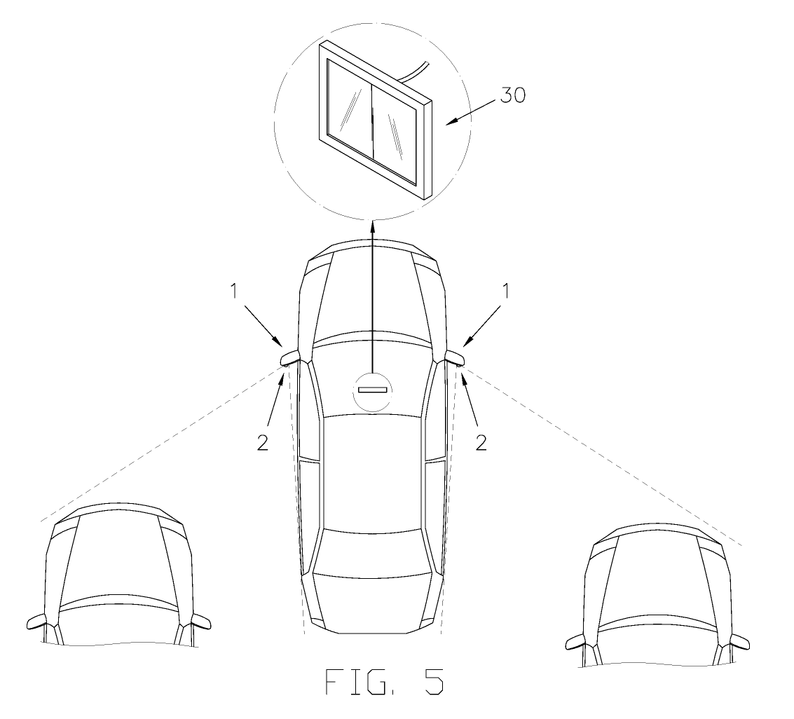

In application, as illustrated in FIGS. 1 and 5, two vehicle exterior mirrors are mounted on two front sides of a vehicle, respectively, and each of the two vehicle exterior mirrors comprises the camera 2, and at least one display 30 is fixed in the vehicle so as to display images photographed by the camera 2 of said each vehicle exterior mirror. As rotating the second lens assembly 12 to the desired angle by using the rotating apparatus 13, the camera 2 rotates to the desired angle of the second lens assembly 12 in response to a rotation of the second lens assembly 12, hence said each camera 2 photographs a rear vehicle, and the images are transmitted to the display 30 so that a driver overtakes a front vehicle or changes driving lane, thus enhancing driving safety.

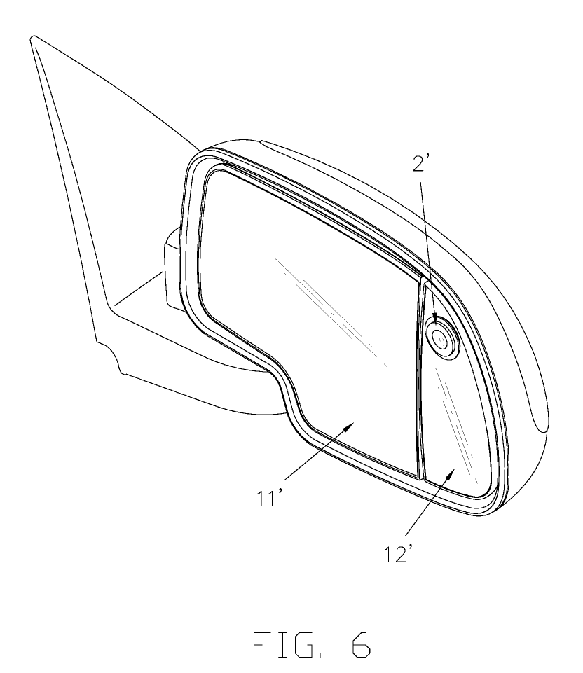

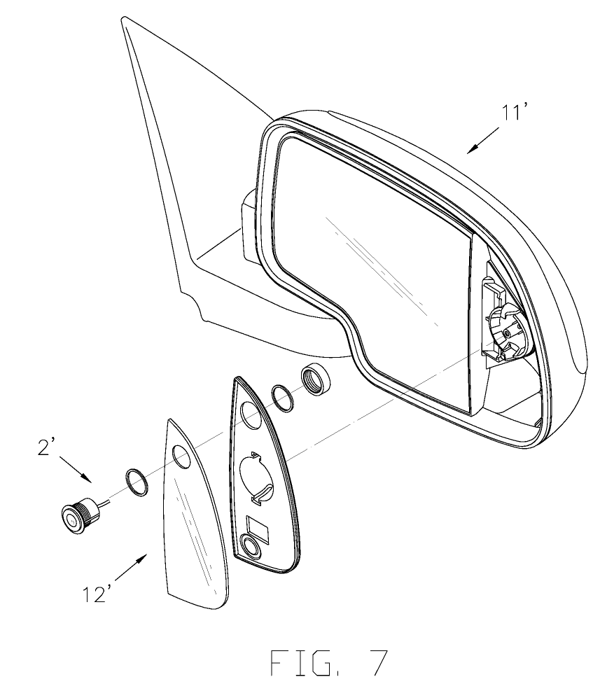

In a second embodiment, as shown in FIGS. 6 and 7, a first lens assembly 11′ and a second lens assembly 12′ are horizontally mounted on one surface of the casing (for instance, the first lens assembly 11 is mounted on a left side of the one surface of the casing 10, and the second lens assembly 12 is mounted on a right side of the one surface of the casing 10, as shown in FIGS. 6 and 7), and a camera 2′ is fitted with the second lens assembly 12′.

Preferably, the first lens assembly 11 and the second lens assembly 12 are rotated to different angles separately, as illustrated in FIG. 1. In another embodiment, after rotating the first lens assembly 11′ to a desired angle, it drives the second lens assembly 12′ to revolve to the desired angle.

Preferably, a number of the lens assemblies is changeable, for example, the body 1 includes one sole lens assembly or three lens assemblies based on using requirements.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A vehicle exterior mirror comprising:
a body including a casing on which at least one lens assembly is mounted, and the casing accommodating at least one rotating apparatus, the at least one lens assembly being in connection with the at least one rotating apparatus respectively and having at least one through orifice defined thereon, individually; and
a camera passing through the at least one through orifice of the at least one lens assembly and fitting with the at least one lens assembly.

2. The vehicle exterior mirror as claimed in claim 1, wherein the at least one lens assembly of the body includes a first lens assembly and a second lens assembly which are both mounted on one surface of the casing, and the first lens assembly is mounted on an upper side of the one surface of the casing, the second lens assembly is mounted on a lower side of the one surface of the casing.

3. The vehicle exterior mirror as claimed in claim 1, wherein the at least one lens assembly of the body includes a first lens assembly and a second lens assembly which are both mounted on one surface of the casing, and the first lens assembly is mounted on a left side of the one surface of the casing, the second lens assembly is mounted on a right side of the one surface of the casing.

4. The vehicle exterior mirror as claimed in claim 1, wherein the at least one rotating apparatus is an electric rotating apparatus or a manual rotating apparatus.

5. The vehicle exterior mirror as claimed in claim 2, wherein the second lens assembly has a fixing mount and a lens connected with the fixing mount, and the fixing mount is coupled with the at least one rotating apparatus, the at least one through orifice has a first through orifice and a second through orifice, and the first through orifice defines on the fixing mount of the second lens assembly, the second through orifice defines on the lens of the second lens assembly and corresponds to the first through orifice, wherein a diameter of the first through orifice of the fixing mount is more than or equal to the second through orifice of the lens; the camera includes a photograph lens module and a locking element, the photograph lens module has a camera lens arranged on a first end thereof, a peripheral tab adjacent to the camera lens, and a connection portion formed on a second end thereof proximate to the peripheral tab, wherein a diameter of the peripheral tab is more than the second through orifice of the second lens assembly, a diameter of the connection portion is less than the second through orifice of the second lens assembly, the connection portion of the camera is fitted with the second through orifice of the second lens assembly and the first through orifice of the fixing mount, and the locking element is screwed with the connection portion so that the camera fits with the fixing mount.

6. The vehicle exterior mirror as claimed in claim 3, wherein, wherein the second lens assembly has a fixing mount and a lens connected with the fixing mount, and the fixing mount is coupled with the at least one rotating apparatus, the at least one through orifice has a first through orifice and a second through orifice, and the first through orifice defines on the fixing mount of the second lens assembly, the second through orifice defines on the lens of the second lens assembly and corresponds to the first through orifice, wherein a diameter of the first through orifice of the fixing mount is more than or equal to the second through orifice of the lens; the camera includes a photograph lens module and a locking element, the photograph lens module has a camera lens arranged on a first end thereof, a peripheral tab adjacent to the camera lens, and a connection portion formed on a second end thereof proximate to the peripheral tab, wherein a diameter of the peripheral tab is more than the second through orifice of the second lens assembly, a diameter of the connection portion is less than the second through orifice of the second lens assembly, the connection portion of the camera is fitted with the second through orifice of the second lens assembly and the first through orifice of the fixing mount, and the locking element is screwed with the connection portion so that the camera fits with the fixing mount.

7. The vehicle exterior mirror as claimed in claim 5, wherein the connection portion has a threaded section defined thereon, and the locking element is a nut configured to screw with the threaded section.

8. The vehicle exterior mirror as claimed in claim 6, wherein the connection portion has a threaded section defined thereon, and the locking element is a nut configured to screw with the threaded section.

9. The vehicle exterior mirror as claimed in claim 5, wherein the camera is fitted with a first sealing element between the peripheral tab and the second lens assembly.

10. The vehicle exterior mirror as claimed in claim 6, wherein the camera is fitted with a first sealing element between the peripheral tab and the second lens assembly.

11. The vehicle exterior mirror as claimed in claim 7, wherein the camera is fitted with a second sealing element between the second lens assembly and the locking element.

12. The vehicle exterior mirror as claimed in claim 8, wherein the camera is fitted with a second sealing element between the second lens assembly and the locking element.

13. The vehicle exterior mirror as claimed in claim 5, wherein the diameter of the first through orifice of the fixing mount is more than the locking element.

14. The vehicle exterior mirror as claimed in claim 6, wherein the diameter of the first through orifice of the fixing mount is more than the locking element.

15. The vehicle exterior mirror as claimed in claim 5, wherein the diameter of the first through orifice of the fixing mount is less than the locking element.

16. The vehicle exterior mirror as claimed in claim 6, wherein the diameter of the first through orifice of the fixing mount is less than the locking element.
